(19) United States
(12) Patent Application Publication
(10) Pub. No.: US 2006/0237451 A1
(43) Pub. Date: Oct. 26, 2006

(54) Ovenware for microwave oven

(76) Inventors: Michael Robert Sameuls, Wilmington, DE (US); Marion G. Waggoner, Landenberg, PA (US); Joel D. Citron, Wilmington, PA (US); Roger Moons, Duffel (BE); Charles J. Molnar, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/293,568

(22) Filed: Dec. 2, 2005

Related U.S. Application Data
(63) Continuation-in-part of application No. 10/627,939, filed on Jul. 25, 2003.
(60) Provisional application No. 60/634,594, filed on Dec. 9, 2004.
(60) Provisional application No. 60/686,360, filed on Jun. 1, 2005.
(60) Provisional application No. 60/424,166, filed on Nov. 6, 2002.
(60) Provisional application No. 60/398,898, filed on Jul. 26, 2002.

(51) Int. Cl. H05B 6/80

(52) U.S. Cl. 219/730

(57) ABSTRACT

Ovenware for microwave ovens which contain a composition comprising a susceptor which has a Curie point temperature of about 100° C. to about 300° C. and a thermoplastic or thermoset polymer are improved and said composition is in contact with the food or drink to be heated or cooked, and/or composition has a thermal conductivity of about 0.7 W/m° K. or more. Heat generated by absorption of microwave radiation by the susceptor is more readily conducted to the food being cooked when the thermal conductivity of the composition is high, particularly when the part containing the susceptor is relatively thick. The relatively low Curie point of the susceptor prevent overheating of the ovenware and food being cooked. Also described are designs for various pieces of ovenware containing this composition.

### CROSS REFERENCE TO RELATED APPLICATIONS

This application claims priority of U.S. Provisional Application No. 60/634,594, filed Dec. 9, 2004, U.S. Provisional Application No. 60/686,360, filed Jun. 1, 2005, and is a continuation-in-part of U.S. patent application Ser. No. 10/627,939, filed Jul. 25, 2003, which claims priority of U.S. Provisional Application 60/424,166, filed Nov. 6, 2002 and U.S. Provisional Application 60/398,898, filed Jul. 26, 2002.

### FIELD OF THE INVENTION

Compositions that contain polymers that have good high temperature resistance, a susceptor for microwave energy generated by a microwave oven and which has a certain Curie point temperature, and that have relatively high thermal conductivities, are useful as ovenware in microwave ovens. Also described are novel structures for such ovenware.

### TECHNICAL BACKGROUND

Common cooking containers such as pots, frying pans, and baking tins are commonly fabricated from metal. People have become used to cooking in metal containers, both for the methods of cooking used and the taste and texture of the foods produced. More recently the use of microwave ovens has become popular, and because of the nature of microwaves, metal containers generally can't be used in such ovens.

In the last 20 years or so, as thermoplastic polymers (TPs) having better high temperature resistance have been developed, the use of these polymers for ovenware has been proposed, see for instance U.S. Pat. Nos. 4,626,557, 4,503,168, 4,585,823, 5,308,913, and 5,141,985, and European Patent Application 846,419, all of which are hereby included by reference. Similar items have been made from thermosetting polymers. These polymeric cooking containers can be used in thermal and/or microwave ovens and often can withstand the highest temperatures usually used in these ovens, for example about 290° C. (˜550° F.) or more. These containers have several advantages. They can be molded into practically any shape so that they may be easily sealed and the contents can be refrigerated or frozen. Also, they are relatively difficult to break, and are relatively low in weight. However, when cooking food in these containers, particularly in a microwave oven, the cooking method (time and/or temperature for example) may have to be varied from the method used for a metal container, or the food will not normally have the same taste and/or texture. For example, bread or a casserole cooked in a plastic container in a microwave oven may not be browned on the outside surface. This is primarily due to the fact that in microwave ovens the heat is relatively uniformly transmitted into the depth of the items being cooked, as opposed to being conducted in from the surface. Also, in a microwave oven there are usually no hot surfaces to impart browning to the item being cooked.

In order to overcome the lack of browning in microwave ovens, as reported in World Patent Application 01/34720, ceramics containing susceptors have been incorporated into ovenware. Often, the susceptor-containing ceramic is in the form of a plate that is part of a ceramic piece of ovenware. This ovenware has the drawbacks of being heavy and brittle. Also, the materials for this ovenware are expensive and hard to form.

In Japanese Patent Application 63-141591 and World Patent Application 01/34702 it has been suggested that polymers resistant to high temperatures, especially liquid crystalline polymers (LCPs), be filled with materials that are susceptors. Materials that have been used include barium titanate and small amounts of carbon fibers. The resulting composition, when formed into ovenware and used in microwave ovens, is said to cause browning of the surfaces of the items being cooked that are in contact with the ovenware. These surfaces are heated because the susceptors in the polymer absorb microwave energy.

The use of various susceptor-containing compositions for use in microwave ovens is known. See for instance U.S. Pat. Nos. 5,021,293, 5,049,714, 4,518,651, 4,851,632 and 4,933,526. In the examples in these patents, the layer containing the susceptor is typically very thin.

The use of susceptors with specific Curie points in microwave ovenware has been reported, see for instance U.S. Pat. Nos. 2,830,162, 4,362,917, 4,454,403, 5,268,546, 5,665,819 and 6,077,454. None of these references report that a polymeric composition containing the susceptor has a high thermal conductivity. In all of these patents the susceptor or susceptor containing composition does not contact the food or drink, but is separated from the food or drink by metal.

### SUMMARY OF THE INVENTION

The present invention is directed to a piece of ovenware adapted for use in a microwave oven. The ovenware, or a portion thereof, is fabricated from a composition that comprises a mixture of a thermoplastic polymer having a melting point and/or glass transition point of about 250° C. or higher, or a thermoset polymer having a softening point that is about 250° C. or more and a heating-effective amount of a microwave susceptor having a Curie temperature of about 100° C. to about 300° C., and optionally with the proviso that the composition has a thermal conductivity of about 0.70 W/m° K. or more when measured through a plane of the composition.

This invention also concerns, a piece of microwaveable ovenware, comprising a composition which comprises a mixture of a thermoplastic polymer whose melting point and/or glass transition point is about 250° C. or more or a thermoset polymer whose softening point is about 250° C. or more, and a heating effective amount of a microwave susceptor having a Curie temperature of about 100° C. to about 300° C., wherein at least part of said composition is in the form of an insert.

The present invention is also directed to a piece of ovenware adapted for use in a microwave oven. The ovenware, or a portion thereof, is fabricated from a composition that comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more, whichever is higher, or a thermoset polymer having a softening point that is about 20° C. or more above a highest Curie point of said susceptors or about 140° C. or more whichever is higher, and optionally with the proviso that the composition has a thermal conductivity of about 0.70 W/m° K. or more when measured through a plane of the composition.

This invention also concerns, a piece of microwaveable ovenware, comprising a composition which comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more whichever is higher, or a thermoset polymer having a softening point that is about 20° C. or more above a highest Curie point of said susceptors or about 140° C. or more whichever is higher, wherein at least part of said composition is in the form of an insert.

Also described is a piece of ovenware, comprising, a composition that comprises a mixture of a thermoplastic polymer having melting point and/or glass transition point of about 250° C. or higher, or a thermoset polymer having a softening point that is about 250° C. or more and a heating-effective amount of a microwave susceptor having a Curie temperature of about 100° C. to about 300° C.,

provided that one or both of the following conditions is met:
when said cookware is in use said composition is in direct contact with the food or drink to be heated and/or cooked; and
said composition has a thermal conductivity of about 0.70 W/m° K. or more when measured through a plane of said composition.

The invention includes a piece of ovenware, comprising, a composition that comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more, whichever is higher, or a thermoset polymer having a softening point that is about 20° C. or more above a highest Curie point of said susceptors or about 140° C. or more whichever is higher;

provided that one or both of the following conditions is met:
when said cookware is in use said composition is in direct contact with the food or drink to be heated and/or cooked; and
said composition has a thermal conductivity of about 0.70 W/m° K. or more when measured through a plane of said composition.

This present invention also includes a process for cooking in a microwave oven, comprising contacting an item to be cooked with the compositions and ovenware described above and exposing the food and the composition to microwave radiation.

In all of the above microwaveable ovenware and in processes for its use it is preferred that the ovenware is configured so that the food or drink which is being heated and/or cooked is in direct contact with the composition which comprises the susceptor having a certain Curie point temperature range.

### BRIEF DESCRIPTION OF THE FIGURES

FIGS. 1-6 illustrate various pieces of microwave ovenware containing inserts that contain susceptors and have relatively high thermal conductivity.

FIG. 7 illustrates an ovenware top of similar construction.

### DETAILS OF THE INVENTION

As used herein, the following terms shall have the following meanings.

By a “susceptor” or “microwave susceptor” (which includes CTSs) is meant a substance that absorbs microwave radiation (MR) of the frequencies that are used in the microwave ovens. Typically, such frequencies are about. 2450 MHz in ovens that are used to cook and/or heat food. Alternatively, the frequency may be 950 MHz or 896 MHz, particularly in commercial microwave ovens. Susceptors may vary in their efficiency in absorbing such MR (see below). When the susceptor absorbs microwave radiation, the energy of the MR is converted to heat.

By “a heating-effective amount of a (microwave) susceptor” is meant an amount such that when an ovenware part containing the susceptor is subjected to MR that part can be heated by the MR such that the food or drink in contact with the part will be heated, preferably cooked, and more preferably browned, seared, or undergo a similar process (collectively herein, browned).

By “ovenware” herein is meant an apparatus that is in contact with the food or drink while it is being cooked and/or heated in an oven, preferably a microwave oven. It may be a “container” such as a bowl, pan (with sides), cylindrical (i.e., the shape of drinking glass), or it may be flat, similar in shape to a flat stone for cooking, for example pizza. In some instances the apparatus may have a cover which may or may not absorb MR. In one preferred form the ovenware is reusable, that is its design and durability are such that it can be reused multiple times, for example much like a metal frying pan can be reused many times. Preferably the cookware is used in a cooking/heating process at least 5 times, more preferably at least 10 times.

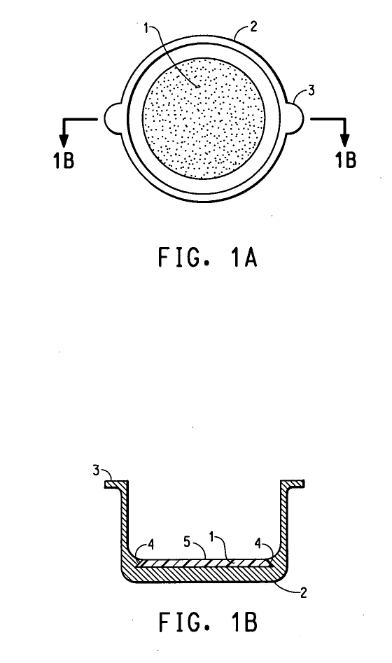

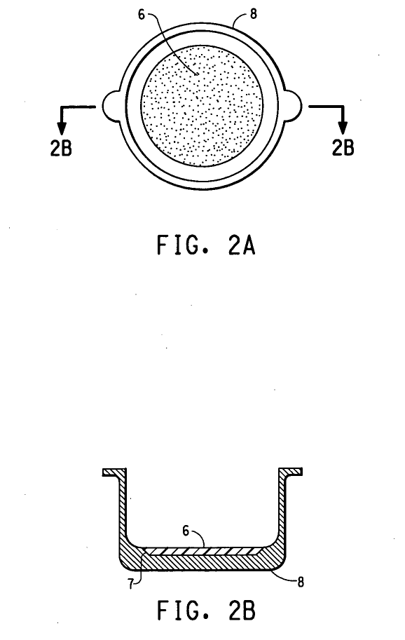

By an “insert” herein is meant a part of a larger apparatus that is usually a piece of ovenware and that is different in composition than the remainder of the piece of ovenware. The insert may be permanently attached to the piece of ovenware or may be detachable or not attached at all to the rest of the ovenware part. For example, if the rest of the piece of ovenware is also a composition which contains thermoplastic polymer, a round cooking pan may be formed by first forming a disk of the composition that contains the susceptor, and then overmolding the disk with a second composition that does not contain a susceptor so that the disk forms the bottom interior surface of the pan. The edge of the disk may be beveled to that it is locked in place when the disk is overmolded by the second composition (see FIG. 1). Another example is a round disk of the susceptor-containing material may be molded and simply placed on top of a disk of the second composition, and the food or drink to be cooked placed on top of the disk that contains the susceptor (see FIG. 2). In both instances the parts that contain the susceptor are considered to be inserts.

By a “mixture” herein is meant a mixture of ingredients (polymer, susceptor, filler, for instance) that is mixed, preferably reasonably uniformly. It does not include an item that contains layers of one or more, but not all, of the ingredients.

By “food” herein is meant cooked or uncooked food and/or drink that is desirable to cook and/or heat.

By “a microwave susceptor consisting essentially of only one or more susceptors having a Curie temperature of about 100° C. to about 300° C.” is meant that the only susceptor(s) present are those that have a Curie temperature of about 100° C. to about 300° C. No susceptors that have a higher or lower Curie temperature or have no Curie temperature before they decompose, melt or vaporize are present in the composition.

By “the food or drink which is being heated and/or cooked is in direct contact with the composition which comprises the susceptor having a certain Curie point temperature range” is meant that the food or drink is in contact with this composition either directly or through a polymeric “membrane” or “film” which is not more than 0.3 mm, preferably no more than 0.2 mm thick. Such a polymeric film may be a release coating such as a fluorocarbon or silicone release material, or a film for the physical protection of the of the susceptor containing, or a film with a pleasing color for better visual appearance, etc. Not all of the food must contact all of the surface of the composition. For example, when cooking a pizza the bottom of the pizza will often become uneven as it cook and the bottom browns, so not all of the pizza bottom will be in contact with the composition.

The composition herein that contains the susceptor also contains a thermoplastic (TP) or thermoset polymer (TSP).

TPs can be reformed by melting the thermoplastic and then cooling it below its melting point and/or glass transition temperature. Such polymers are not crosslinked. Except as otherwise noted, the TPs have a melting point and/or glass transition temperature above about 250° C., preferably above about 300° C., more preferably above about 340° C., and especially preferably above about 370° C., when measured by differential scanning calorimetry, with the melting point being taken as the peak of the melting endotherm, and the glass transition temperature as the middle of the transition. Such measurements can be done following ASTM method D3418, at a heating rate of 10° C./min. If the polymer has no melting point (if amorphous) and no glass transition temperature, then its decomposition point shall be used.

The TPs useful in the present invention should preferably have sufficient thermal resistance so that they will not melt or flow when exposed to MR in a microwave oven, when they contain food and/or drink, as they are designed to do. More preferably they should not melt or flow when the ovenware is exposed to MR in a microwave oven and food or drink is not present. Typically such ovens for household use have a maximum output of microwave energy of about 1500 watts.

Useful thermoplastics include polyolefins; polyesters such as poly(ethylene terephthalate) and poly(ethylene 2,6-napthalate); polyamides such as nylon-6,6 and a polyamide derived from hexamethylene diamine and isophthalic acid; polyethers such as poly(phenylene oxides); poly(ether-sulfones); poly(ether-imides); polysulfides such as poly(p-phenylene sulfide); liquid crystalline polymers (LCPs) such as aromatic polyesters, poly(ester-imides), and poly(ester-amides); poly(ether-ether-ketones); poly(ether-ketones); fluoropolymers such as polytetrafluoroethylene, a copolymer of tetrafluoroethylene and perfluoro(methyl vinyl ether), and a copolymer of tetrafluoroethylene and hexafluoropropylene; and mixtures and blends thereof.

A preferred type of TP is an LCP. By a “liquid crystalline polymer” is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present.

TSPs may be used in place of TPs in the susceptor-containing compositions. The TSPs should have a softening temperature of about 250° C. or more, preferably above about 300° C., more preferably above about 340° C., and especially preferably above about 370° C., when measured by ASTM method D648 (Heat Deflection Temperature), Method A, at a load of 1.82 MPa. Useful TSPs include epoxy resins meant for high temperature use, and bis(maleimide)triazines.

TPs are preferred types of polymers for use in the present invention.

The thermal conductivities of virtually all TPs and TSPs, including those types listed above, is generally <<1 W/m° K. Because microwaves are absorbed within the depth of the susceptor-containing material, it is possible to have substantial temperature gradients through the thickness of the material. These gradients may be large enough that the interior of the susceptor-containing material melts while the outer surface stays solid. To avoid such situations, the susceptor-containing material should have a thermal conductivity of about 0.7 W/m° K. or more.

The thermal conductivity of the susceptor-containing composition can be raised by mixing the TP or TSP with a particulate material (filler) which itself has a relatively high thermal conductivity, such as about 10 W/m° K. or more, more preferably about 20 W/m° K. or more. Useful fillers are reported below with their approximate thermal conductivity at about 273° K. in parentheses, as reported by Y. S. Touloukian, et al., in Thermophysical Properties of Matter, Vol. 2, IFI/Plenum, New York, 1970.) Useful fillers include graphite (including carbon black and carbon fibers) (50-200, varies widely), MgO (60), BeO (200), alumina (45-150), zinc oxide (28), CaF₂ (700), boron nitride (125-300, not in Touloukian) and SiC (˜100-500). Preferred thermally conductive fillers are graphite, MgO, and alumina, carbon black and carbon fibers. Especially preferred thermally conductive fillers are graphite, carbon black, boron nitride and carbon fibers.

More than one such filler may be used. Generally speaking, the higher the amount of thermally conductive filler used, the higher the thermal conductivity of the TP or TSP composition will be. The upper limit of thermally conductive filler that can be used may be determined more by its effect on the physical strength and toughness of the composition than by the actual thermal conductivity achieved. These thermally conductive fillers, especially those that are not also susceptors, may optionally be added to the susceptor containing compositions to increase the thermal conductivity to the desired level.

Useful susceptors are known in the art. Materials that are useful susceptors include selected inorganic compounds, semiconductors and poor electrical conductors such as carbon and metals. Specific materials include aluminum (powder or dust), carbon (in various forms such as carbon black, graphite powder, and carbon fiber), barium titanate, and metal oxides such as zinc oxide, and iron oxides such as magnetite. In some instances metals may not be a favored form of susceptor.

A favored form of susceptor comprises a susceptor that has a minimum Curie temperature of about 100° C., more preferably about 120° C., and especially preferably about 150° C. and a maximum Curie temperature of about 300° C., more preferably about 275° C., and especially preferably about 250° C. It is to be understood that any such minimum temperature may be combined with any such maximum temperature to form a preferred Curie temperature range. Such susceptors are termed herein “Curie temperature susceptors”, CTS. Preferably the susceptor in the composition contains only one or more CTSs.

By a Curie point temperature is meant that the susceptor has a temperature above which it is not a susceptor, i.e., it does not absorb a significant amount microwave radiation above that temperature. Although not bound by theory, it is believed that this is due to a phase change which results in the material changing from ferromagnetic or ferrimagnetic to paramagnetic material around the Curie temperature, see McGraw-Hill Encyclopedia of Science and Technology, 7^{th} Ed., Vol. 4, McGraw-Hill Book Co., New York, 1992, p. 623, which is hereby included by reference.

Preferably the CTSs are the only susceptors in the composition. When this is the case, the thermoplastic polymer having a melting point and/or glass transition point of about 20° C. or more above a highest Curie temperature of said susceptors or about 140° C. or more whichever is higher, or a thermoset polymer having a softening point that is about 20° C. or more above a highest Curie temperature of said susceptors or about 140° C. or more whichever is higher. Preferably these melting, glass transition or softening temperatures are about 40° C. or more above the highest Curie temperature, more preferably about 60° C. or more above the highest Curie temperature, and especially preferably about 100° C. or more above the highest Curie Temperature. If only one such susceptor is present, then its Curie temperature is used for the purpose of calculating the minimum melting, glass transition or softening temperature, as appropriate.

If the compositions containing the CTS(s) are present in the cookware in the form of inserts, or the cookware otherwise contains polymeric compositions that do not contain susceptors, it is preferred that at least those polymeric compositions in direct contact with the compositions containing the CTS(s) have the same thermal properties, i.e., melting, glass transition or softening points, as are required or preferred for the CTS containing compositions. Preferably the CTS containing compositions are in (at least partial) direct contact with the food being heated and/or cooked while being exposed to the MR.

Useful CTSs are known in the art, for example ferrite materials, see for instance U.S. Pat. Nos. 5,665,819, 6,077,454, both of which are hereby include by reference, and ferromagnetic alloys and metals. Preferably the CTS is not a metal or metal alloy. Preferably the CTS is a ferrite, a magnetic oxide, see for instance McGraw-Hill Encyclopedia of Science and Technology, 7^{th} Ed., Vol. 7, McGraw-Hill Book Co., New York, 1992, p. 53-54, which is hereby included by reference.

If the cookware being exposed to the MR is empty, or part is not in contact with the food, or the food/drink is dried out by heating too long, it is possible the melting, softening and/or decomposition temperature of the TP or TS resin may be exceeded, thereby causing damage to the cookware. Indeed if the temperature of the cookware or its contents gets too high, a fire may result. If the susceptor is a CTS, then when the cookware (actually the CTS) reaches its Curie point it will cease (or at least diminish) the conversion of the MR generated by the microwave oven to thermal energy and a further temperature rise will be slowed or not occur. This is a safety feature which prevents overheating of the cookware to protect the cookware and also to prevent a fire. In some cases, particularly when the cookware has a specific purpose, for example is a “pizza stone” to heat a pizza, the Curie point may be chosen so that the bottom surface of the pizza is not overheated by the cookware, and an optimum browning (for instance in the case of pizza crust) occurs.

Indeed, different inserts containing CTSs having different Curie temperatures may be used to optimize heating, browning or crisping in different parts of the food item, or to make up for uneven distribution of the MR in the oven. For example when cooking a round pizza which is a bit smaller in diameter than the length and/or depth of the microwave oven, oftentimes less microwave radiation reaches the bottom of the crust near the center of the pizza compared to the periphery of the pizza. In that case an insert underneath the center area of the pizza may contain relatively more CTS and or use a CTS with a higher Curie temperature than an insert which contacts the bottom of the pizza more towards the periphery of the pizza. Other such combinations will be evident to the skilled person.

The concentration of the susceptor in the TP- or TSP-based composition (along with the mass of the composition and the efficiency of the susceptor) will determine what fraction of the MR will be absorbed. The higher the fraction absorbed by the susceptor-containing composition, the less is available to be directly absorbed by the food or drink in any particular cooking situation. The higher the fraction of MR that is absorbed by the susceptor-containing composition, the hotter that composition will get. In some instances the concentration of the susceptor in the TP- or TSP-based composition may also affect the temperature which the composition can reach in the microwave oven. If this does happen, generally speaking the higher the concentration of susceptor, the higher the temperature that can be reached, unless the susceptor stops absorbing microwave radiation because it is above its Curie point.

One material may serve to function as both a susceptor and thermally conductive filler. For example various forms of carbon are susceptors and have high thermal conductivities. Carbon, for instance in the form of graphite powder, carbon fiber or carbon black is a preferred combined susceptor and thermally conductive filler. Metal in the form of powders or dusts also are susceptors and have high thermal conductivities.

Preferably the filler(s) and susceptors should be relatively small particles. Typically the largest dimension (on average)for a particulate material should be less than about 500 μm, and if fibrous material is used the length(on average) should be less than 1 mm. The fillers and susceptors are preferably uniformly dispersed in the TP or TSP. They may be mixed into the TP using standard melt mixing techniques and equipment, such as single or twin screw extruders. They may be mixed into the TSP before the TSP is crosslinked by standard mixing methods used for uncrosslinked TSPs.

The thermal conductivity of the compositions in some cases must be about 0.7 W/m° K. or more, preferably about 1.0 W/m° K. or more, more preferably about 2.0 W/m° K. or more, very preferably about 3.0 W/m° K. or more, and especially preferably about 5.0 W/m° K. or more. However, inserts and other ovenware types which contain susceptors, as described herein, need not have relatively high thermal conductivities in all instances, for example where the insert is relatively thin and or is efficiently cooled in the ovenware of which it is a part. The TP or TSP preferably are present as a continuous phase in the composition. Typically the high thermal conductivity filler (or susceptor if the susceptor also has a high thermal conductivity) is about 5 to about 85% by weight of the composition. The thermal conductivity of the composition is measured through a plane (thinnest cross section) of a test part or piece of ovenware, using ASTM Method E1530.

The thermal conductivity of polymer compositions (not containing substantial amounts of susceptors) previously described for ovenware is typically quite low. For instance, using an LCP with the same composition as LCP-4 of U.S. Pat. No. 5,110,896, which is hereby included by reference, and which had the composition (in molar parts) of 50/50/70/30/320 hydroquinone/4,4′-biphenol/terephthalic acid/2,6-napthalene dicarboxylic acid/4-hydroxybenzoic acid, a composition containing 51.6% LCP, 13% of a blue pigment concentrate in the LCP, 35% talc and 0.56% Ultranox® antioxidant (all percentages are by weight of the total composition) was made and molded into a disc. At 100° C. the through the plane of the disc heat conductivity was 0.40 W/m° K.

One important consideration in the design of ovenware containing a susceptor is transferring the heat that is generated by the absorption of the MR by the susceptor to the food being cooked. This is particularly true when the susceptor is contained in a part whose thickness (at least in a portion of the part) is about 50 μm or more, more particularly when the thickness is about 100 μm or more, and very particularly when the thickness is about 200 μm or more. Polymers in general have poor thermal conductivity. If the heat within the susceptor-containing material is not conducted out of that material, its temperature, especially internally, will rise, and heat will not be efficiently transmitted to the food being cooked. This, of course, negates some of the benefits of using a susceptor-containing material. Perhaps just as important, if the temperature of the susceptor-containing material (particularly a susceptor that does not have a Curie temperature below the melting or softening point of the polymer) rises to the melting point or glass transition temperature (whichever is higher) of the TP or TSP of the composition, the susceptor-containing material may melt, decompose, or even catch fire, or the food being cooked may be ruined and/or catch fire. The same may be true for a composition that is in contact with the susceptor-containing material, for example the material in contact with the inserts as shown in FIGS. 1 to 6. Therefore, when the susceptor-containing material has thicknesses as described above, it is advantageous that the susceptor-containing composition also have a relatively high thermal conductivity.

FIGS. 1-6 show various pieces of ovenware constructed according to the present invention. FIG. 1 shows a frying or cooking pan from the top (FIG. 1a) and in cross section (FIG. 1b). In FIG. 1a, 1 is an insert containing a susceptor which has an upper surface 5. 2 is the body of the frying pan that is made of a thermoplastic composition that has no susceptor and a relatively low thermal conductivity. The body 2 is overmolded over the edge of 1, and both of 3 are (optional) molded-in handles. FIG. 1b shows 1, 2, and 3 in cross section, and in particular shows the beveled edge 4 of 1, and how 2 is overmolded over this beveled edge to hold 1 in place. In addition the pan of FIG. 1 may also have feet (not shown, and which may be molded as part of 2) of the composition of 2 to hold the pan above the bottom of the microwave oven, thereby allowing the MR to readily heat the bottom center of 1 by bouncing off a metal bottom of the microwave oven. Because handles 3 are made from a composition not containing a susceptor and have relatively low thermal conductivity, they remain relatively cool through the cooking process, and often allow the pan to be picked up without burning the cook's fingers. The high thermal conductivity of the insert 1 allows heat to flow readily to the upper surface 5 and hence to the food being cooked. This prevents overheating of 1 and/or 2. The pan of FIG. 1 may be used to brown the bottom of food while cooking, as a frying pan (with or without added oil or grease), or may be used much as a pot on a surface cooktop. Most of the comments about the pan of FIG. 1 are applicable to the ovenware shown in the other Figures.

FIG. 2 shows a cross section of a pan similar to that in FIG. 1, except insert 6 has an edge 7 which is “reverse beveled”, allowing 6 to be removed from the body 8 for easy cleaning of 6 and/or 8, and/or easy replacement of 6 and/or 8.

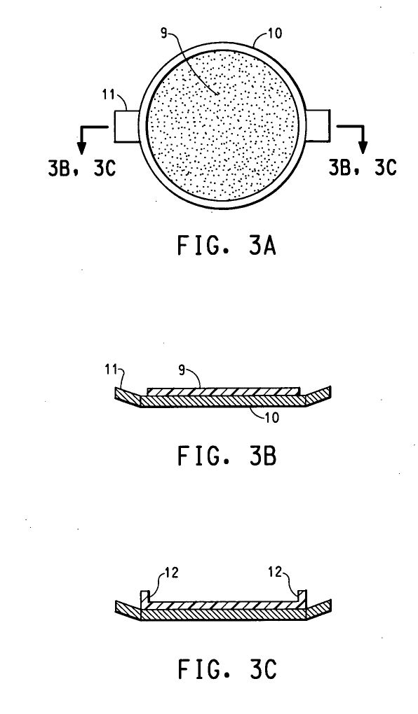

FIG. 3 shows a top view (FIG. 3a) and a cross section (FIG. 3b) of a “pizza stone” in which an insert 9 merely rests upon the base 10 that has handles 11. The base may optionally have molded in feet (not shown) to hold the stone above the bottom of the microwave oven as is also optional in the pan. The base 10 may have a slight recess slightly larger than the diameter of 9 so 9 does not readily slide off 10 if the pizza stone is tilted during transport (to the table). FIG. 3c shows an alternate construction of 9 that has raised edges 12. These raised edges may prevent the pizza from slipping off 9, and/or aid in browning the edges of the pizza (not shown).

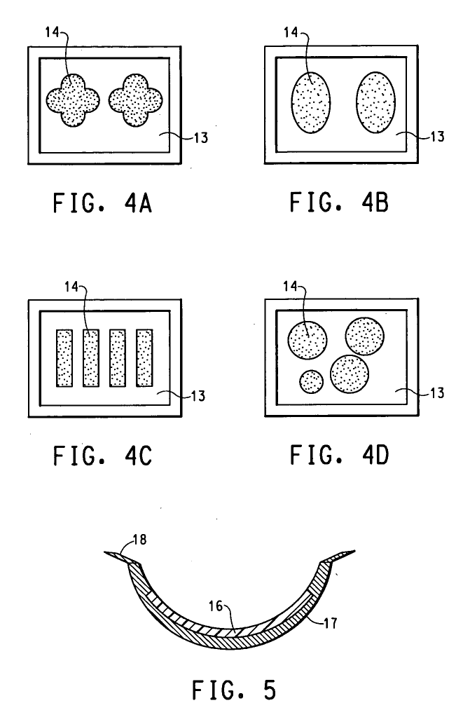

FIG. 4 shows top views of several rectangular pans 13, with each pan having two or more inserts 14 present in various patterns. These inserts may be overmolded much like the inserts of the pan of FIG. 1, and each of 14 may have beveled edges similar to 4.

FIG. 5 shows a cross section of a microwave wok, with the insert 16 being at the bottom of the generally spherical wok (the thermal heat source for a wok is usually underneath the wok) being overmolded with a body 17 that has handles 18.

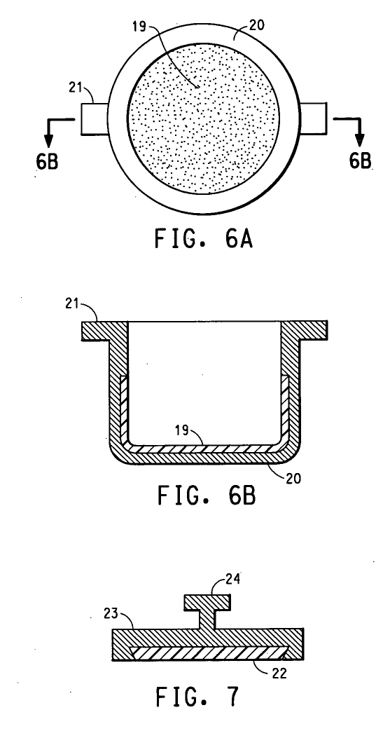

FIG. 6 shows a top view (FIG. 6a) and a cross section (FIG. 6b) of a cylindrical piece of ovenware having an insert 19 inside a body 20 that has handles 21. The insert may cover the entire bottom and most of the interior sides as shown in FIG. 6, or may just cover part of the interior bottom and/or sides (not shown). By using the microwave oven at a low power level this type of ovenware may simulate a so-called slow cooker or crock cooker, which not only heats the food being cooked but also tends to brown the food in contact with the cooking vessel sides and/or bottom.

The ovenware item (such as those in FIGS. 1-6) may also have a top (see FIG. 7) which fits on top of the ovenware item or directly on top of the food in the ovenware item. This top may simply be used to close off the top of the ovenware item, much as a top is used on a conventional metal pot. However the top, particularly when in direct contact with the food, may also be the composition as described herein containing a susceptor and having a certain minimum thermal conductivity. The susceptor-containing composition may be present in the top as an insert, analogous to the inserts shown in FIGS. 1-6. In some instances only the top may contain the susceptor-containing material, particularly when the object is to brown the top of the food item being cooked. In that instance the ovenware item may be an ordinary ovenware item as is used today. FIG. 7 shows such a top with the susceptor-containing composition present as insert 22 overmolded with 23, another composition which does not contain a susceptor, the overmolding composition having handle 24. In some instances it may be preferable that 25 be smaller than the container holding the food (not shown), so that the top directly contacts the top of the food (not shown). Tops containing the susceptor-containing compositions described herein are also considered pieces of ovenware herein.

It is noted that in all of the above Figures (and generally) where multiple inserts are present in a piece of ovenware each of the inserts may have a different susceptor or combination of susceptors with different Curie temperatures. In this way different parts of the food in the ovenware may be heated differentially. Also, single inserts shown in the Figures may be divided into two or more contiguous inserts containing different susceptors or combinations of susceptors with different Curie temperatures.

In another type of ovenware, especially for commercial applications, the susceptor-containing material may be a conveyor belt, especially the surface of the conveyor belt which contacts the food resting upon the conveyor belt. This would therefore be a mechanism for browning the surface of the food that was in contact with the surface of the conveyor belt.

In some instances it may be preferable that the surface of the food being cooked and/or heated in contact with the susceptor containing polymer be crisp when the cooking/heating is completed. For instance pizza crusts and many baked goods often preferably have a crispy surface. If the surface of the susceptor containing polymer in contact with the food is smooth, water vapor formed during the cooking/heating process may not be readily able to escape, thereby resulting in a soft (mushy/soggy) textured food surface. It has been found that if the surface contains “water vapor escape channels” the surface of the food is often much crispier. By these channels is meant grooves, surface irregularities, knurled pattern channels, holes or other “channels” through which the water vapor formed in the cooking/heating process may escape from between the food's surface and the susceptor containing polymer's surface. Such channels may be formed by convention means, for example they may be machined or embossed into the surface of the susceptor containing polymer, but it is preferred that these channels be formed during the molding process for insert or other surface of the susceptor in contact with the food surface.

A preferred type of food using the cookware described herein and/or in the cooking processes described herein is pizza.

The manufacture of the above cookware items can be carried out by conventional melt forming techniques, for example injection molding. When an insert is “locked into” the ovenware item, for instance as in FIG. 1, the insert may be overmolded by a polymeric composition that does not contain a susceptor. In this type of situation it is preferred that the TP or TSP of the insert and of the overmolding composition have the same or nearly the same composition (the polymer itself, not the fillers and other materials, if any mixed with the polymer). This helps to avoid differential shrinkage and subsequent cracking and/or loosening of the insert. If LCPs are used for both parts, it is preferred that the overall orientation in these parts from the molding operation be in the same direction in the final ovenware item. If the melting points or glass transition points of polymers of the insert and overmolding composition are the same or similar, one must be cautious not to significantly melt or otherwise deform the insert during the overmolding operation.

All of the polymeric compositions described herein may contain other ingredients typically added to thermoplastics (or thermosets), such as fillers, reinforcing agents, plasticizers, flame retardants, pigments, antioxidants, antiozonants, and lubricants, in the amounts usually used for such compositions. These additives may somewhat affect the thermal conductivity, and any thermal conductivity limitations must still be met.

The ovenware items may be coated fully or partially (including coating of compositions containing a susceptor) with various types of release coatings which prevent the food being cooked from sticking to the ovenware and/or allowing easier cleaning of the ovenware. For example various types of fluoropolymer-containing coatings may be used, such as those available under the Teflon® and Silverstone® brand names. Silicone release coating may also be used.

For the susceptor-containing compositions (such as the inserts in FIGS. 1-6) to have a desirable level of durability in a reusable piece of ovenware, it should preferably be at least about 0.25 mm thick, more preferably at least about 0.50 mm thick.

The ovenware items described herein are especially useful in microwave ovens wherein the usual mode of cooking (cooking herein includes both initial cooking and simple (re)heating of food and drink) is absorption of MR by the food or drink being cooked or heated. Most microwave ovens use just MR to provide thermal energy, but some also have a convection (thermal) heating source. The ovenware described herein may be used in both of these types of microwave ovens. The ovenware items may often also be used in “ordinary” convection ovens since these items often have good thermal resistance.

When cooking in a convection oven or a microwave oven one wants to balance the overall thermal history of the mass of food with the amount of browning that takes place, usually on one or more surfaces. For example in a convection oven if the temperature of the oven is too high the outside surface of the food item may brown too much, i.e. be burned, before the interior of the item is fully cooked. Thus a loaf of bread could be burned on the outside before the interior of the loaf is fully baked. In order to control such factors in a convection oven, through experience and experimentation cooks have learned to adjust food recipes, the cooking temperature, the cooking container (material), and the shape and mass of the food being cooked to control the relative amounts of cooking vs. browning. Similar considerations come into play in cooking in a microwave oven with the present ovenware. To some extent one should preferably balance the amount of MR which is directly absorbed by the food being cooked with the amount of MR which is being absorbed by the susceptor and converted to heat. This heat from the susceptor is conducted by the (relatively high heat conduction) composition to the surface of the food being cooked, where the heat is transferred to the food's surface. The relative amounts of MR absorbed directly by the food and the susceptor are influenced by the relative masses, shapes and configurations of the susceptor and the food, as well as the pattern of MR in the oven. In turn the mass, shape and configuration of the susceptor is determined by concentration of the susceptor in the susceptor-containing composition, the volume and especially the thickness of this composition, the thermal conductivity of the susceptor-containing composition, and the relative position of this composition versus the position of the food in the oven. Another variable that can affect the amount of browning vs. the degree of cooking is the recipe for the food itself. Some experimentation may be needed, but this is a normal process when designing new cooking containers and/or recipes for foods.

In order to obtain the desired balance of properties, particularly MR absorption efficiency and thermal conductivity, in the susceptor-containing compositions, one can use separate materials to act as a susceptor and as a thermally conductive filler, and balance each property separately (the presence of these two materials will affect the performance of the other somewhat because each occupies a volume percentage of the composition), or it may be possible to use a single material which is a susceptor and is highly thermally conductive, or any combination of these.

Curie temperatures may be determined by an adaptation of ASTM Method E1582-00, Procedure C. This method is designed to calibrate instruments for thermogravimetric analysis using, in this procedure, a Curie temperature standard. Instead of using a standard, the analysis is run with the material whose Curie temperature is to be determined on a previously calibrated instrument. The heating rate is 5° C./min. As shown in FIG. 1 of the method, the Curie temperature is taken as the inflection point of the temperature vs. apparent weight chart which is generated.

In the Examples, the following materials were used:
Boron Nitride (BN)—PolarTherm® PT160 from General Electric Advanced Materials, USA
Ferrite 1—A Mn/Zn ferrite reportedly having the formula (MnO.ZnO.Fe₂O₃)(FeO.Fe₂O₃) and a reported Curie temperature of 125° C. and obtained from Steward, Inc., Chattanooga, Tenn. 37407, USA, and sold by them as #74000. This ferrite also reportedly has a density of 5.15 g/cm³, and an average particle size of 10 μm (Coulter).
LCP A—A liquid crystalline polyester containing repeat units derived from hydroquinone/terephthalic acid/2,6-naphthalene dicarboxylic acid/4-hyroxybenzoic acid in the molar ratio 100/5/95/100, and had a melting point of 359° C.

### EXAMPLE 1

A melt blend of 50 weight percent LCP A and 50 weight percent Ferrite 1 was made by melt mixing in a 30 mm Werner & Pfleiderer (Stuttgart, Germany) twin screw extruder. The LCP was fed at the back and Ferrite 1 was side fed. There were 9 barrels, and barrel 2 was 148° C., barrel 3 was 304° C., and the rest of the barrels were 345-357° C. The screw was operated at 250 rpm, which gave a production rate of about 13.6 kg/h. The resulting blend was extruded into strands and cut into pellets. These pellets were then injection molded, in an HPM 6 oz. single screw injection molding machine with barrel temperatures set to 370° C., into circular 10.2 cm dia.×0.32 cm thick discs.

A disc was placed into a Panasonic® Model NN-6470A microwave oven (this oven was made for the consumer cooking market) equipped with a turntable and which had a power input of 1.54 kW. Also placed into the oven was a beaker containing 400 ml of water to absorb “excess” microwave radiation if the ferrite was above the Curie temperature (this water was changed as needed to prevent excessive boiling). The oven was turned on at high power for 1 min, and then the disc was removed briefly and its temperature measured with an infrared pyrometer. The total time of exposure to microwave radiation and the measured temperature are given in Table 1.

TABLE 1

| Time, Min | Temp., ° C. |
|---|---|
| 0 | 28.9 |
| 1 | 151.0 |
| 2 | 172.0 |
| 3 | 187.0 |
| 4 | 198.7 |
| 5 | 223.0 |
| 6 | 233.2 |
| 7 | 235.6 |
| 9 | 245.0 |
| 10 | 257.9 |
| 11 | 265.0 |

A 5.08 cm diameter disc was cut from one of the molded discs and its thermal conductivity through its thickness measured. The composition had a thermal conductivity of 0.355 W/m° K.

### EXAMPLE 2

The thermoplastic composition used was the 10.2 cm diameter discs described in Example 1. The microwave oven used was also as described in Example 1, but without the 400 ml of water present.

The first food to be tested were “Bagel Bites” with a cheese, sausage and pepperoni topping. These were partially cooked bagel halves (cut perpendicular to the bagel hole's axis) topped on the flat side with the meats, cheese and tomato sauce. After some experimentation with varying times and power levels, after cooking for 7 min. at low power the topping was nicely heated and melted, and the bottom of the bagel was nicely browned where it had contacted (or was in near contact) the disc. At the end of the cooking the disc temperature was measured as 116° C.

The next food to be tested was a “Celeste®”s a Pizza for One”, topped with cheese, tomato sauce and pepperoni. The pizza was cut into 8 wedges, and the wedges were individually tested. Again after some experimentation varying times and cooking levels, a nicely cooked pizza with a browned bottom crust was obtained after 6 min at low power. At the end of cooking the disc temperature was 99° C.

### EXAMPLE 3

A melt blend of 1157 g percent LCP A, and 679 g Ferrite 1, and 727 g of BN was made by melt mixing in a 30 mm Werner & Pfleiderer (Stuttgart, Germany) twin screw extruder. The materials were powder blended and fed at the back of the extruder. There were 9 barrels, and barrel 2 was about 223° C., barrel 3 was about 302° C., and the rest of the barrels were 344-358° C. The screw was operated at 300 rpm, which gave a production rate of about 13.6 kg/h. The resulting blend was extruded into chunks and the chunks chopped into “pellets”. These pellets were then injection molded, in an HPM 6 oz. single screw injection molding machine with barrel temperatures set to 370° C., into circular 10.2 cm dia.×0.32 cm thick discs.

Using the microwave oven of Example 1 a disc was placed into the oven. Also placed into the oven was a beaker containing 400 ml of water to absorb “excess” microwave radiation if the ferrite was above the Curie temperature (this water was changed as needed to prevent excessive boiling). The oven was turned on at high power for 1 min, and then the disc was removed briefly and its temperature measured with an infrared pyrometer. The total time of exposure to microwave radiation (in minutes) and the measured temperature (° C.) are given in Table 2.

TABLE 2

| Time, min | Temp., ° C. |
|---|---|
| 0 | 23 |
| 1 | 120 |
| 2 | 129 |
| 3 | 133 |
| 4 | 133 |
| 5 | 134 |
| 6 | 139 |
| 7 | 140 |
| 8 | 143 |
| 9 | 142 |

A 5.08 cm diameter disc was cut from one of the molded discs and its thermal conductivity through its thickness measured. The composition had a thermal conductivity of 0.645 W/m° K.

### EXAMPLE 4

The thermoplastic composition used was the 10.2 cm diameter discs described in Example 4. The microwave oven used was also as described in Example 1, but without the 400 ml of water present.

A “Celeste® Pizza for One”, topped with cheese, tomato sauce and pepperoni was used. The pizza was cut into 8 wedges, and the wedges were

What is claimed is:

1. A piece of ovenware, comprising, a composition that comprises a mixture of a thermoplastic polymer having melting point and/or glass transition point of about 250° C. or higher, or a thermoset polymer having a softening point that is about 250° C. or more and a heating-effective amount of a microwave susceptor having a Curie temperature of about 100° C. to about 300° C.,
provided that one or both of the following conditions is met:
when said cookware is in use said composition is in direct contact with the food or drink to be heated and/or cooked; and
said composition has a thermal conductivity of about 0.70 W/m° K. or more when measured through a plane of said composition.

2. A piece of ovenware, comprising, a composition that comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more, whichever is higher, or a thermoset polymer having a softening point that is about 20° C. or more above a highest Curie point of said susceptors or about 140° C. or more whichever is higher;
provided that one or both of the following conditions is met:
when said cookware is in use said composition is in direct contact with the food or drink to be heated and/or cooked; and
said composition has a thermal conductivity of about 0.70 W/m° K. or more when measured through a plane of said composition.

3. The ovenware as recited in claim 1 or 2 wherein at least a portion of said composition in said ovenware has a thickness of about 100 μm or more.

4. The ovenware as recited in claim 1 or 2 also comprising a top which comprises said composition.

5. The ovenware as recited in claim 1 or 2 wherein said thermoplastic polymer is used.

6. The ovenware as recited in claim 5 wherein said thermoplastic polymer is a liquid crystalline polymer.

7. The ovenware as recited in claim 1 or 2 wherein said thermal conductivity is about 2.0 W/m° K. or more.

8. The ovenware as recited in claim 1 or 2 further comprising water vapor escape channels.

9. The ovenware as recited in claim 1 or 2 additionally comprising a filler having a thermal conductivity of about 20 W/m° K. or more.

10. A piece of microwaveable ovenware, comprising a composition which comprises a mixture of a thermoplastic polymer whose melting point and/or glass transition point is about 250° C. or more or a thermoset polymer whose softening point is about 250° C. or more, and a heating effective amount of a microwave susceptor having a Curie temperature of about 100° C. to about 300° C., wherein at least part of said composition is present in the form of an insert.

11. A piece of microwaveable ovenware, comprising a composition which comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more whichever is higher, or a thermoset polymer having a softening point that is about 20° C. or more above a highest Curie point of said susceptors or about 140° C. or more whichever is higher, wherein at least part of said composition is present in the form of an insert.

12. The ovenware as recited in claim 10 or 11 wherein at least a portion of said composition in said insert has a thickness of about 100 μm or more.

13. The ovenware as recited in claim 10 or 11 wherein said thermoplastic polymer is present.

14. The ovenware as recited in claim 10 or 11 wherein said insert further comprises water vapor escape channels.

15. The ovenware as recited in claim 10 or 11 wherein in normal use said insert is in contact with food or drink which is being heated and/or cooked.

16. A process for cooking in a microwave oven, comprising, contacting an item to be cooked with a composition which comprises a mixture of a thermoplastic polymer whose melting point and/or glass transition point is about 250° C. or more or a thermoset polymer whose softening point is about 250° C. or more, a heating effective amount of a microwave having a Curie temperature of about 100° C. to about 300° C., and exposing food in contact with said composition to microwave radiation.

17. A process for cooking in a microwave oven, comprising, contacting an item to be cooked with a composition which comprises a mixture of a heating-effective amount of a microwave susceptor consisting essentially of only one or more susceptors having a Curie temperature of about 100° C. to about 300° C., and a thermoplastic polymer having a melting point and/or glass transition point of about 20° C. or more above a highest Curie point of said susceptors or about 140° C. or more, whichever is higher, or a thermoset polymer having a softening point that is about 20° C. or more above a highest Curie point of said susceptors or about 140° C. or more whichever is higher, and exposing food in contact with said composition to microwave radiation.

18. The process as recited in claim 16 or 17 wherein said composition has a thermal conductivity of about 0.70 W/m° K. or more when measured through a plane of said composition.

19. The process as recited in claim 16 or 17 wherein at least a portion of said composition in said ovenware has a thickness of about 100 μm or more.

20. The process as recited in claim 16 or 17 wherein said thermoplastic polymer is used.

21. The process as recited in claim 20 wherein said thermoplastic polymer is a liquid crystalline polymer.

22. The process as recited in claim 16 or 17 wherein said thermal conductivity is about 2.0 W/m° K. or more.

23. The process as recited in claim 16 or 17 wherein said composition further comprises water vapor escape channels.

24. The process as recited in claim 16 or 17 wherein cookware comprising said composition is reused in said process.

25. The process as recited in claim 16 or 17 wherein a pizza is cooked and/or heated during said process.

26. The process as recited in claims 16 or 17 wherein said susceptor is a ferrite.

27. The ovenware as recited in claims 12, 10 or 11 wherein said susceptor is a ferrite.
